(19) United States
(12) Patent Application Publication
(10) Pub. No.: US 2006/0061599 A1
(43) Pub. Date: Mar. 23, 2006

(54) Method and apparatus for automatic image orientation normalization

(75) Inventors: Hong Heather Yu, Princeton Junction, NJ (US); Prabir Bhattacharya, Plainsboro, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/944,683

(22) Filed: Sep. 17, 2004

(51) Int. Cl. G09G 5/00; G06K 9/32; G06K 9/00

(52) U.S. Cl. 345/649; 382/181; 382/296

(57) ABSTRACT

In some embodiments, systems and methods for visually rendering images rotate images at time of display based on annotations indicating needed rotations. In other embodiments, systems and methods for visually rendering images rotate images at time of display by determining a needed rotation for an image based on automatic orientation recognition. In further embodiments, systems and methods for visually rendering images rotate images at time of display by utilizing fuzzy logic to determine a best rotation angle for an image based on a none precise marking generated by computer vision or signal processing applied to the image. In yet further embodiments, systems and methods for annotating images annotate images at time of image capture, time of image display, or any time in between by using one or more of automatic image orientation recognition, user input specifying a needed rotation, and sensed orientation of an image capture mechanism.

### FIELD OF THE INVENTION

The present invention generally relates to digital image review and display, and relates in particular to automatic normalization of image orientation.

### BACKGROUND OF THE INVENTION

Today's portable image capture devices, particularly digital cameras, are typically capable of capturing images in memory for later display and/or sharing by transmission. Such imaging devices are typically capable of being held in various orientations during image capture. As a result, an image may not appear to be right side up when later viewed on a display of the device or on another display receiving the shared image. This lack of proper orientation can be problematic. For example, while the image capture device can also be rotated to view the displayed image in a right side up orientation, such rotation also rotates other user interface components of the device. Also, a desktop display receiving a shared image is not so easily rotated. Further, physical rotation of the entire display does not simultaneously properly orient multiple images previewed as a batch and having different orientations. Yet further, rotating the images in memory can be time consuming for users. Further still, it may not be apparent after the fact which way is “up” on a photograph, especially in the case of crime scene photos. Accordingly, there remains a need for a system and method that automatically properly orients images for users.

### SUMMARY OF THE INVENTION

In some embodiments, systems and methods for visually rendering images rotate images at time of display based on annotations indicating needed rotations. In other embodiments, systems and methods for visually rendering images rotate images at time of display by determining a needed rotation for an image based on automatic orientation recognition. In further embodiments, systems and methods for visually rendering images rotate images at time of display by utilizing fuzzy logic to determine a best rotation angle for an image based on a none precise marking generated by computer vision or signal processing applied to the image. In yet further embodiments, systems and methods for annotating images annotate images at time of image capture, time of image display, or any time in between by using one or more of automatic image orientation recognition, user input specifying a needed rotation, and sensed orientation of an image capture device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a set of images depicting various orientations of image capture devices and resulting images, and the needed rotations for batch viewing of such images;

FIG. 2 is a block diagram depicting image orientation normalization in a home AV server in the case of non-recordable media according to some embodiments of the present invention.

FIG. 3 is a block diagram depicting image orientation normalization in a home AV server in the case of recordable media according to some embodiments of the present invention.

FIG. 4 is a flow diagram depicting orientation recognition procedures according to some embodiments of the present invention.

FIG. 5 is a view of example image object characteristics employed to accomplish automatic orientation recognition according to some embodiments of the present invention; and

FIG. 6 is a set of block diagrams illustration various procedures for transmission and display of annotated images according to some embodiments of the present invention.

### DETAILED DESCRIPTION OF THE PREFERRED EMBODIMENTS

The following description of the preferred embodiments is merely exemplary in nature and is in no way intended to limit the invention, its application, or uses.

Some embodiments of the present invention accomplish automatic image orientation by annotating the stored image according to its proper orientation and automatically reorienting the image for display as needed according to the annotation. Other embodiments determine the proper orientation “on the fly” at time of display using an automatic image orientation recognition process according to the present invention; this procedure can be applied to all pictures, to all new pictures, or to all unannotated pictures, with reoriented images subsequently saved in the new orientation, annotated, or left alone. The annotation can be generated for an image in several ways. For example, the user can annotate the image manually by rotating it on the display and saving the rotation as the annotation; thus, annotation is different from creating a new image by resaving the image in the new orientation. Also, the image capture device may be equipped with device orientation sensors, such as one or more mercury switches, and can be adapted to automatically label the image according to sensed orientation of the device when the image is captured and stored. Further, an automated image feature recognition technique can be employed to detect the proper orientation of the image and annotate the stored image accordingly.

Subsequent discussion of the present invention will use three cases as examples: (1) home image database on non-recordable media; (2) home image database on recordable media; and (3) instant photo sharing with normalized orientation at remote locations. However, the present invention should not be limited to these illustrative examples.

In the subsequent discussion, the following symbols will be used to represent the image display or viewing orientation and the orientation of the main object in the image.

[symbol] image display orientation, up, down, left, right.

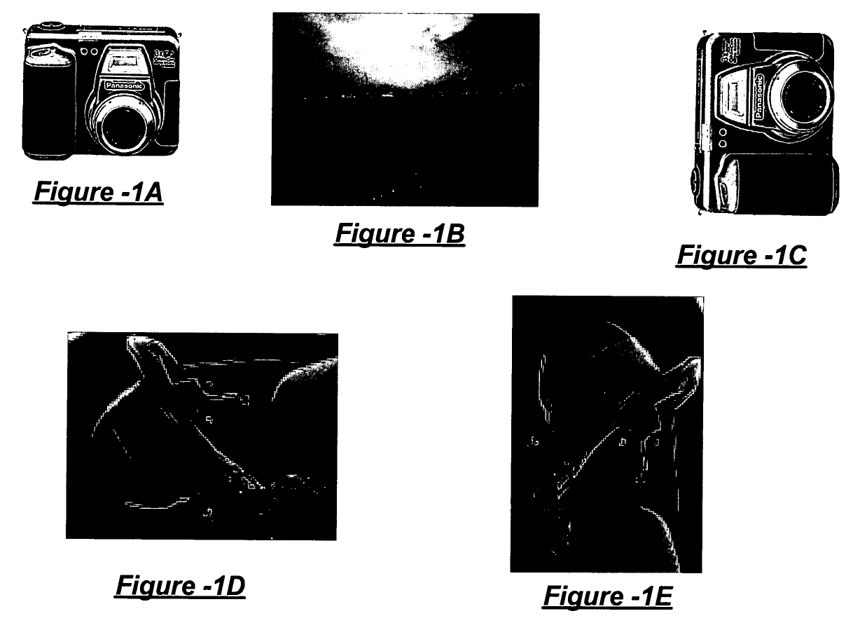

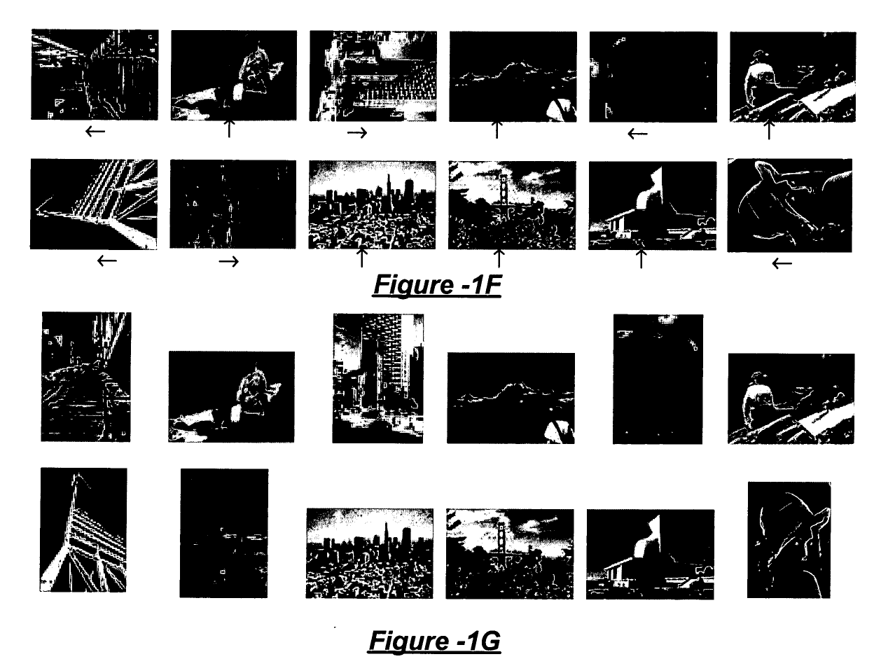

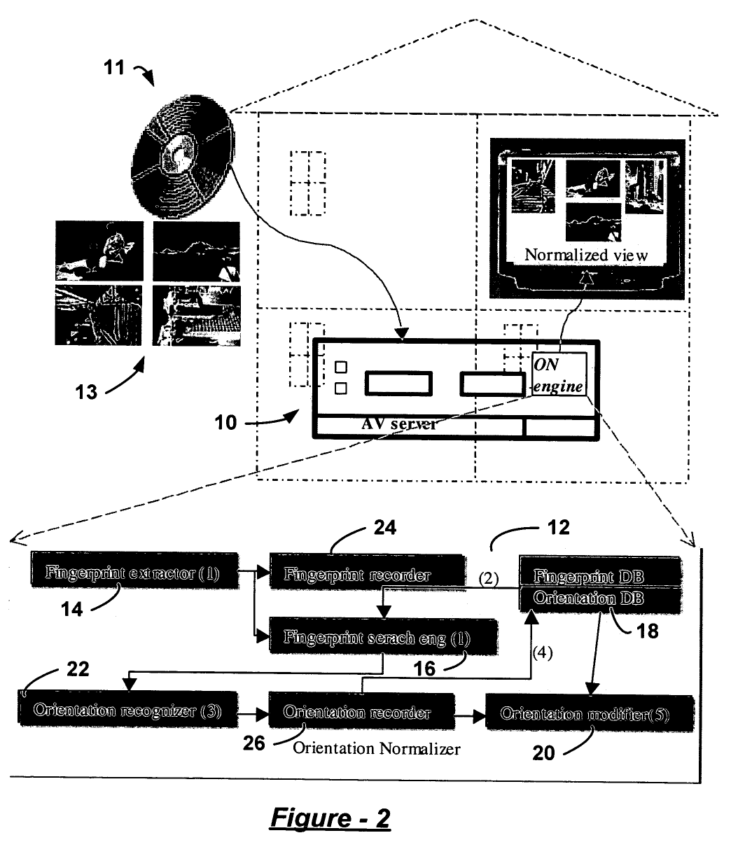

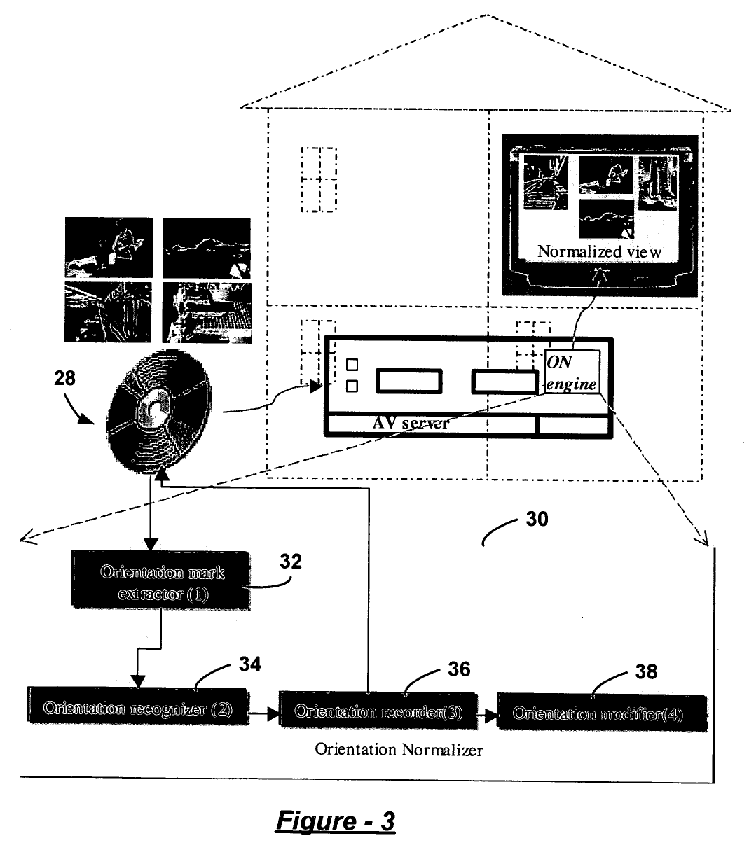

↑ ↓ ← → object orientation, up, down, left, right. For example, the image in FIG. 1D has an [symbol] image display orientation while the orientation of the object in the image, the person, is ←.

In reference to an upright orientation [symbol] , a 90° clockwise (to [symbol] 180° clockwise (to [symbol] or 90° counter-clockwise (to [symbol] rotation a regular rotation and otherwise irregular rotations. In accordance, [symbol] are called regular orientation, whereas an arbitrary rotation will result in an irregular orientation.

FIG. 1A shows a regular digital camera. It can be used in a normal way (see FIG. 1A) to take a landscape picture, as shown in FIG. 1B. It can also be physically rotated 90° clockwise or 90° counter-clockwise (see FIG. 1C) to take a portrait (FIGS. 1D-E). The second mode is largely used when one wants to take a close shot of a person or an object that has a longer height than its width. When previewing or browsing the images/photos using the camera preview function or software in a computer, the display orientation is fixed in the currently available tools. An example is shown in FIG. 1F. There is one drawback: a user previewing the picture often needs to rotate his or her head or else the display to take a good look at those pictures that were taken with the camera rotated 90° clockwise or 90° counter-clockwise. Currently available software can allow manual rotation of a picture to its object orientation. However, the manual rotation is a somewhat annoying and time consuming process because users have to rotate and resave each disoriented picture one at a time. Users also have to tell the computer which direction and how much degree to rotate. In other words, achieving a better preview such as the one shown in FIG. 1G with every picture's object in the more easily viewable upright orientation ↑, a manual rotation operation on six out of twelve pictures shown in FIG. 1F is needed.

An automatic orientation normalizer, however, can save the viewer this trouble with just a simple click. Manual annotation, i.e., manually marking the preferred viewing orientation of each picture in the database, may provide best results for auto ON. However, when the database is large the process of manual annotation can be too time consuming to realize. Most home audio visual (AV) servers are likely to have a large image/picture database due to the availability of low cost digital camera and memory. To provide orientation normalization functions to a home AV server, content-based automatic orientation normalization capability is needed. Similar techniques can be employed to obtain an image previewer/browser with ON functionality.

Generally speaking, there are two different types of cases that can be considered: (a) previously taken & saved images/pictures including: (1) a home image database on non-recordable medium; or (2) a home image database on recordable medium; and (b) new pictures including (1) instant photo sharing with normalized orientation at a remote location; or (2) real time orientation marking in digital photonic devices.

The method of automatic image orientation normalization for use with an AV server 10 having non-recordable media 11 according to the present invention is carried out by orientation normalizer 12 performing one or more of the following steps: (1) a small fingerprint of each picture 13 is extracted by fingerprint extractor 14 and compared by fingerprint search engine 16 with the fingerprint database 18 in the AV server 10; (2) if a matching fingerprint is found, the image orientation of the corresponding picture is obtained from the database 18 for orientation modification by orientation modifier 20; (3) if a matching fingerprint is not found, orientation recognition algorithms are used by orientation recognizer 22 to recognize the orientation of the picture (in some embodiments, a hierarchical recognition system facilitates 1D color and edge projection, and Hidden Markov Models (HMMs) with hierarchical categorization are used for orientation recognition); (4) the orientation (2 bits-3 bits) along with the fingerprint of the picture is saved in the AV server database 18 by fingerprint recorder 24 and orientation recorder 26; (5) when pictures are to be shown, the user may choose ‘normalized orientation’ to display the pictures, and the normalizer can rotate the images to their normalized orientation to display it on the screen. It should be noted that the fingerprint data and the orientation data can be saved/obtained from a remote server or secure server.ome embodiments of the present invention implement a home image database on recordable medium 28. Compared with non-recordable medium, the difference is that the fingerprint of the image and the orientation can be saved on the recordable medium 28. Furthermore, the image orientation can be saved in the image header or hidden in the image itself using robust data hiding algorithms for a permanent orientation marking. The method of hidden orientation marking is carried out by orientation normalizer 30 performing one or more of the following steps: (1) image orientation is first checked against an image header and/or watermark to see if there is an existing orientation marker; if yes, the orientation is extracted by orientation mark extractor 32; (2) otherwise, orientation recognition algorithms are used by orientation recognizer 34 to recognize the orientation of the picture, and the orientation is obtained; (3) the orientation (2 bits-3bits) is then saved into the picture header or the picture itself by orientation recorder 36; (4) when pictures are to be shown, the user can choose ‘normalized orientation’ to display the pictures, and the normalizer 30 can rotate the images to their normalized orientation to display them on the screen using orientation modifier 38.

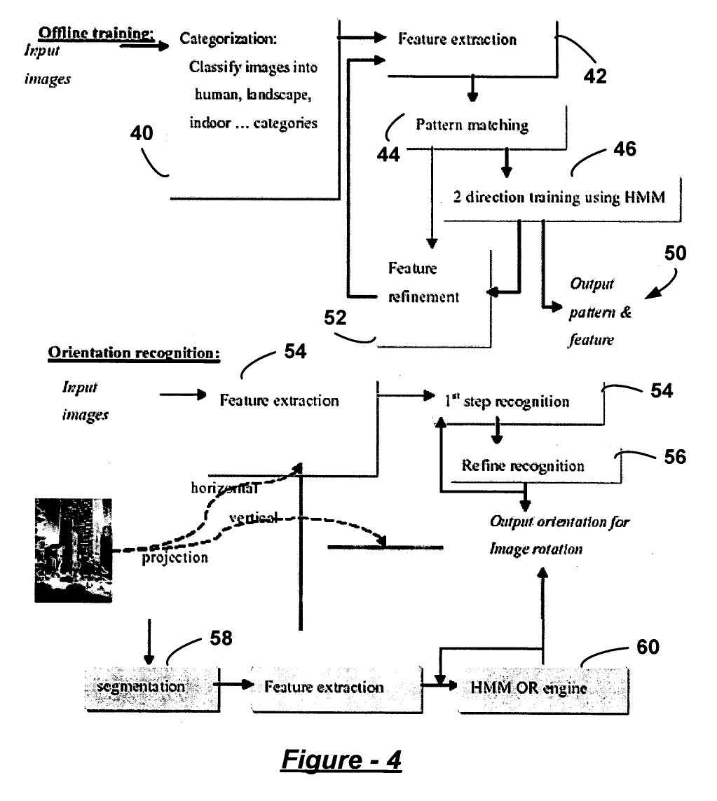

Orientation recognition (OR) can be accomplished according to some embodiments of the present invention in order to accomplish automatic image orientation normalization. For automatic image orientation normalization, it is desirable to provide a high orientation recognition rate, and a simple user interface with easy operation for orientation normalization. To achieve high recognition rate, pattern recognition algorithms that leverage offline training, feedback tuning, and real time and/or non-real time orientation recognition can be utilized. A general system architecture flow graph is illustrated in FIG. 4.

Offline training begins with image categorization at step 40, followed by feature extraction at step 42 and pattern matching at step 44. Two direction training using hidden markov models (HMMs) at step 46 results in an output pattern and feature at 48 as well as feature refinement at step 50, which feeds back into future feature extraction procedures.

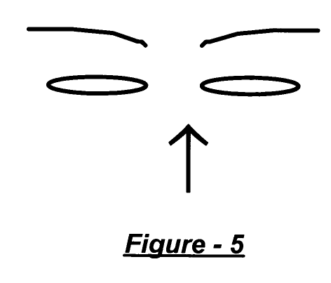

For human object, previous study has shown a high accuracy using human eyebrow and eye pattern line to locate the human face object in images as shown in FIG. 5. Eigenface and Neural network techniques are two of the well known successful methods for accomplishing such location. These techniques can be modified and used to normalize the orientation of the image as shown in FIG. 5. For better trade off between speed and recognition rate, a hierarchical recognition system with hierarchical categorization can be used. After feature extraction performed on input images at step 52 (FIG. 4), simple features and a fast algorithm for a fast track recognition are used in the first level of hierarchy at step 54. Then, more complicated features and more sophisticated algorithms for more accurate recognition are used in a second level of hierarchy at step 56. In addition, multiple hierarchies of categories can be used to facilitate minimum total processing time for a large image database. Image feature extraction can be preceded by image segmentation at step 58. Some embodiments use multi-dimensional projection based feature extraction in conjunction with pattern recognition algorithms, such as HMM (Hidden Markov Model) to facilitate orientation recognition. Accordingly, an image (e.g., a landscape type image) is first projected on multiple dimensions. Features are then extracted from each projection. Those features are then used in a pattern recognition based or any other possible feature recognition algorithms. Usually there is a training process involved for algorithms such as HMM and Neural Network based algorithms. Alternatively or additionally, orientation recognition patterns can be trained on extracted features at step 60 based on a user specified orientation, especially in the case where the automatic orientation recognition attempt fails. For best real time processing results, maximum offline processing power should be explored. Steps may be taken to automatically start the OR process right after picture/image downloading and allocate processing power for the OR process while the server is working on other tasks.

Some embodiments of the present invention include real time orientation marking in a digital camera/AV server. Two kinds of orientation marking methods maybe used, namely: (1) a header based method; and (2) a robust data hiding based method. It is envisioned that the header based method can equivalently include any type of tagging external to the image, such as metatags; the term “header” should not be construed to mandate that the annotation be located within a particular header of the image. For a transcoding safe solution that does not lose the orientation mark when the image format is changed or image modification is performed, a digital watermarking technology can be utilized. A multi-level data hiding technology can be employed to hide an orientation watermark into each image. The watermark can be robust to content preserving signal processing, such as compression. The extracted watermark can then be used to normalize the image orientation.

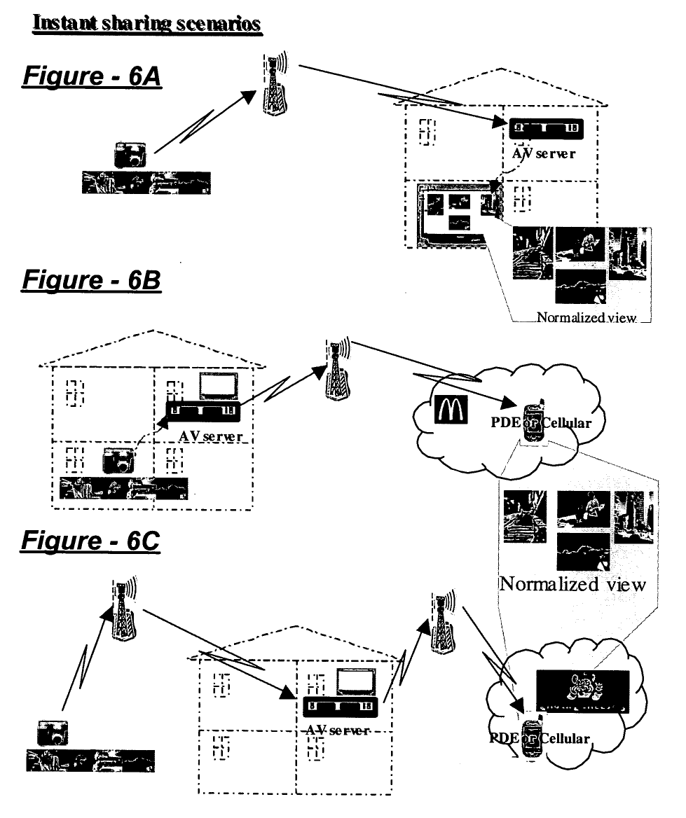

In some embodiments of the present invention, the system can provide one click operation capability for batch image browsing with a normalized view via a pointer flipping operation according to the following procedure: (1) after a picture is taken, an orientation mark is recorded in the header or hidden in the image; (2) the picture is transmitted to a home AV server through a secure network connection as illustrated in FIGS. 6A-6C; (3) the picture can be viewed instantly on the home display or on a remote device such as a Personal Digital Assistant (PDA) or cellular phone. When pictures are to be shown, a user may choose ‘normalized orientation’ to display the pictures. The normalizer accordingly rotates the images to their normalized orientations to display them on the screen.

It should be noted that the image orientation mark can affect bit rate of annotated image transmission. JPEG is one of the most widely used image formats for digital camera captured images. Accordingly, JPEG is used as an example in subsequent discussion. Notably, the JPEG standard format has a comments and annotation area, which facilitates image orientation marking.

Normal object orientation can be defined with just two bits of information; the normal object orientations are defined above according to: ‘↑ ↓ ← → object orientation, up, down, left, right.’ Thus, two bits of information can be used to record the normal object orientation as follows: 00 ↑, 01→, 10 ←, 11 ↓.

Abnormal object orientation, such as [symbol] , [symbol] , [symbol] , and [symbol] , can also be considered, by using three bits for the orientation mark according to: 000 ↑, 001→, 010 ←, 011 ↓, 100 [symbol] , 101 [symbol] , 110 [symbol] , 111 [symbol] . Hence the total bit rate increase is <4 bits.

Irregular orientation normalization can also be employed. In contrast to regular orientation normalization (i.e., the image shall be rotated 90° cw, 180° cw, or 90° ccw only), irregular orientation normalization involves recognition and identification of an image orientation in arbitrary direction and consequently rotates it an arbitrary degree to an upright direction. When irregular rotation is involved, the problem is relatively harder. Therefore, other technologies may be needed for the hardware and software implementation. In this case, fuzzy logic is a good choice for the job. Fuzzy logic enables control engineers to easily implement control strategies used by human operators, i.e., to deal with a complex system with the ease of describing human knowledge. Some embodiments of the present invention include a method to normalize picture orientations using fuzzy logic. More specifically, when the image orientation is marked automatically using computer vision or signal processing, it is considered a none precise marking. When none-precise marking is presented, fuzzy logic is utilized to decide the best rotation angle and thereafter rotate (i.e., normalize the image orientation) accordingly. This technology is especially useful for previously saved image databases. VLSI chips using fuzzy logic are widely available, which economizes the hardware implementation of such an application. Accordingly, it is envisioned that the use of computer vision and computer graphics algorithms together can yield a reasonable result for this problem.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for visually rendering images, comprising:
accessing memory storing an image having an annotation indicating a needed rotation for proper orientation of the image;
performing a rotation of the image based on the annotation; and
visually rendering the image according to the rotation.

2. The method of claim 1, further comprising annotating the image to indicate the needed rotation.

3. The method of claim 2, further comprising determining the needed rotation based on automatic orientation recognition.

4. The method of claim 3, further comprising performing automatic orientation recognition, including applying pattern recognition algorithms to predefined features of the image.

5. The method of claim 4, further comprising using hierarchical recognition with hierarchical categorization to initially recognize relatively simple image features, and subsequently recognize relatively more complicated image features.

6. The method of claim 4, further comprising using human eyebrow and eye pattern line features to locate a human face object in the image.

7. The method of claim 2, further comprising annotating the image based on a rotation of the image specified by a user.

8. The method of claim 2, further comprising annotating the image based on a sensed orientation of an image capture device.

9. The method of claim 1, further comprising:
utilizing fuzzy logic to determine a best rotation angle for the image based on a none precise marking generated by computer vision or signal processing applied to the image; and
rotating the image according to the best rotation angle.

10. The method of claim 1, further comprising extracting the annotation from a header of the image.

11. The method of claim 1, further comprising extracting the annotation as a digital watermark from the image.

12. A method for visually rendering images, comprising:
determining a needed rotation for an image based on automatic orientation recognition;
performing a rotation of the image based on the needed rotation; and
visually rendering the image according to the rotation.

13. The method of claim 12, further comprising performing automatic orientation recognition, including applying pattern recognition algorithms to predefined features of the image.

14. The method of claim 13, further comprising using hierarchical recognition with hierarchical categorization to initially recognize relatively simple image features, and subsequently recognize relatively more complicated image features.

15. The method of claim 13, further comprising using human eyebrow and eye pattern line features to locate a human face object in the image.

16. The method of claim 12, further comprising annotating the image to indicate the needed rotation.

17. The method of claim 16, further comprising storing the annotation in a header of the image.

18. The method of claim 16, further comprising storing the annotation as a digital watermark in the image.

19. A method for visually rendering images, comprising:
utilizing fuzzy logic to determine a best rotation angle for an image based on a none precise marking generated by computer vision or signal processing applied to the image;
performing a rotation of the image based on the best rotation angle; and
visually rendering the image according to the rotation.

20. The method of claim 19, further comprising applying computer vision or signal processing to the image to generate the none precise marking.

21. A method for annotating images, comprising:
accessing an image stored in computer memory;
determining a needed rotation for the image to achieve a proper orientation of the image when the image is visually rendered to a user; and
annotating the image to indicate the needed rotation.

22. The method of claim 21, further comprising determining the needed rotation based on automatic orientation recognition.

23. The method of claim 22, further comprising performing automatic orientation recognition, including applying pattern recognition algorithms to predefined features of the image.

24. The method of claim 23, further comprising using hierarchical recognition with hierarchical categorization to initially recognize relatively simple image features, and subsequently recognize relatively more complicated image features.

25. The method of claim 23, further comprising using human eyebrow and eye pattern line features to locate a human face object in the image.

26. The method of claim 21, further comprising annotating the image based on a rotation of the image specified by a user.

27. The method of claim 21, further comprising annotating the image based on a sensed orientation of an image capture device.
